(19) United States
(12) Patent Application Publication
(10) Pub. No.: US 2017/0146731 A1
(43) Pub. Date: May 25, 2017

(54) SIDE GRATING BASED LIGHT COUPLING SYSTEM

(71) Applicant: National Taipei University of Technology, Taipei City (TW)

(72) Inventors: YIN-WEN LEE, Taipei City (TW); SHENG-LUNG HUANG, Taipei City (TW); YEN-YIN LI, Taipei City (TW)

(21) Appl. No.: 15/132,268

(22) Filed: Apr. 19, 2016

(30) Foreign Application Priority Data
Nov. 25, 2015 (TW) 104139127

(51) Int. Cl. G02B 6/02; G02B 6/34

(52) U.S. Cl. CPC G02B 6/02061; G02B 6/34

(57) ABSTRACT

A side grating based light coupling system comprises an optical fiber, a side grating disposed on one side of the lateral wall of the optical fiber, and a laser array disposed adjacent to the other side of the lateral wall of the optical fiber. The side grating comprises a plurality of grating elements arranged in a non-uniform arrangement. The laser array for generating a laser beam towards and passes through the optical fiber, and the laser beam is converted into at least one laser beam through the plurality grating elements. The diffraction efficiencies of the converted laser beams are different. The converted laser beams propagate inside the optical fiber based on total internal reflection. The plurality of grating elements of the side grating are heterogeneous arrangement without loading the optical collimating lens, and can reduce scattering loss by controlling the asymmetric diffraction efficiency, to improve optical coupling efficiency.

### CROSS-REFERENCE TO RELATED APPLICATION

This application claims the priority of Taiwanese patent application No. 104139127, filed on Nov. 25, 2015, which is incorporated herewith by reference.

### BACKGROUND OF THE INVENTION

1. Field of the Invention

The present invention relates to a side grating based light coupling system, especially a side grating based light coupling system with the asymmetric diffraction efficiencies.

2. The Prior Arts

In Taiwan Patent No. 200947002 “Gratings At Optical Fiber Side And Coupling Apparatus Using The Same”, the invention describes the conventional technology which is to provide a grating at optical fiber side and coupling apparatus. As shown in FIG. 1, a fiber side-coupling apparatus comprises: a semiconductor laser diode bar array 50, disposed at one side of an optical fiber 51, producing pump beams and through optical collimation system 54; and a cladding grating 52. The cladding grating 52 comprises: a plurality of grating members 53, periodically formed on a cladding surface at the other side of the optical fiber 51 and opposite to the laser diode bar array 50 of an inner cladding, the plurality of grating members 53 are arrayed along a longitudinal direction of the optical fiber 51, wherein the grating members 53 diffract the pump beams to produce diffracted beams propagating in the inner cladding of the optical fiber 51; and a reflection layer, disposed on the grating members 53, configured to reflect the diffracted pump beams into the optical fiber 51. However, as for the cladding grating 52 structure of the present invention having a small vertical scale, therefore, when making the cladding grating 52 on the surface of the optical fiber 51, the mechanical strength of the optical fiber 51 is not reduced. The diffraction angles of the cladding grating 52 satisfy the condition of the total internal reflection to avoid the reflection loss.

In Taiwan Patent No. 1446081 “Transversely Pumping Fiber Amplifier”, the invention describes the conventional technology which is to provide a transversely pumping fiber amplifier comprises: a gain fiber having a first end, an opposite second end and an illuminating area located between the first end and the second end; a pump source; and a first and a second reflective metal layers. The pump source disposed at one side of the gain fiber is utilized to launch a pump light and illuminate the illuminating area. The first and the second reflective metal layers separately formed on the first end and the second end of the gain fiber reflect the pump light.

In US Patent No. 2009/0285528 A1 “Cladding Grating And Fiber Side-Coupling Apparatus Using The Same”, the invention describes a cladding grating for directing pump beams from a laser diode bar array, disposed at one side of an optical fiber, into the inner cladding of the optical fiber, the cladding grating comprising: a plurality of grating members, periodically formed on a cladding surface at the other side of the optical fiber, opposite the laser diode bar array, of an inner cladding, arrayed along a longitudinal direction of the optical fiber, Wherein the grating members diffract the pump beams to produce diffracted beams propagating in the inner cladding of the optical fiber; and a reflection layer, disposed on the grating members, configured to reflect the diffracted pump beams into the optical fiber.

However, since the fiber structure of the prior art uses grating elements with a specific periodic structure parameters. It has strict requirements regarding the incident angle and collimation quality of the incident laser beam. In addition, advanced collimating lens and elements are required to achieve good coupling efficiencies.

Therefore, relevant industry would have additional manufacturing costs, rather than in line with the production of cost-effectiveness. On the other hand, since the technology of the prior art is limited to the specific periodic structure parameters of the grating elements, the secondary diffraction loss and scattering loss due to edge are inevitable, so that the efficiency of coupling light and final energy conversion efficiency are difficult to improve.

Accordingly, the present invention is to provide a lateral grating based light coupling system, which exhibits asymmetric diffraction efficiencies, and there reduce the secondary diffraction loss and scattering loss due to edge. And on the other hand, due to the relatively relaxed requirements for the incident angle and collimation of the incident light source, it is not required to load the optical collimating lens, and can reduce the costs associated with the industry in the production of spent. In fact, it is anxious to solve technical problems of the prior art in the present day.

### SUMMARY OF THE INVENTION

Due to the foregoing disadvantages of the conventional technology, the main object of the present invention is to provide a side grating based light coupling system, and it is possible to reduce the secondary diffraction loss and scattering loss due to edge without the use of the optical collimating lens. Thus, it can achieve the purpose of reducing production cost, wear and tear, and improving the energy conversion efficiency.

To achieve the foregoing and other objects, the side grating based light coupling system of the present invention comprises: an optical fiber, having a first side wall and a second side wall opposite to the first side wall; a side grating, located near the first side wall of the optical fiber, wherein the side grating includes a plurality of grating elements arranged in non-uniform arrangement; a laser array, disposed adjacent to the second side wall of the optical fiber, to emit a laser beam toward the optical fiber; wherein the laser beam sequentially goes through the second side wall and the first side wall of the optical fiber, the laser beam is converted into at least one laser beam through the plurality grating elements. The diffraction efficiencies of the converted laser beams are different where the converted laser beams propagate inside the optical fiber based on total internal reflection.

In the side grating based light coupling system of the present invention, the laser array emits the laser beam toward the second side wall of the optical fiber, and the laser beam sequentially goes through the second side wall and the first side wall of the optical fiber. Then, the laser beam is converted into at least one laser beam through the plurality grating elements. The diffraction efficiencies of the converted laser beams are different. The converted laser beams propagate inside the optical fiber based on total internal reflection.

Since the plurality of grating elements were arranged in non-uniform arrangement without loading the optical collimating lens, it can reduce the secondary diffraction loss and scattering loss due to edge, to achieve the purpose of reducing cost to improve the energy conversion efficiency.

### BRIEF DESCRIPTION OF THE DRAWINGS

The invention will be described according to the following:

FIG. 1 illustrates an structure diagram of a fiber side-coupling apparatus of the prior art;

FIG. 2 illustrates a system structure diagram of a side grating based light coupling system of the present invention;

FIG. 3 illustrates a diagram of a relationship between a depth of the microstructure of a plurality of grating elements, and the overall energy conversion efficiency of the side grating based light coupling system of the present invention; and

FIG. 4 illustrates a diagram of a relationship between the incident laser beam power and the efficiency of coupling light of the side grating based light coupling system of the present invention.

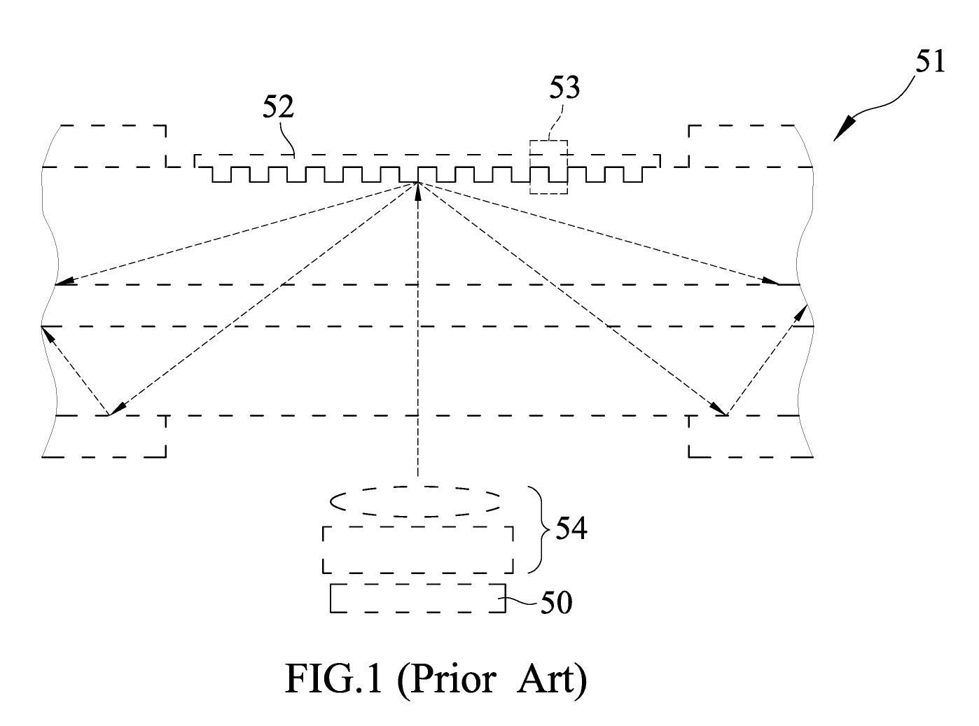

### DETAILED DESCRIPTION OF THE PREFERRED EMBODIMENT

Hereinafter, described embodiments of the present invention by certain specific embodiments, the person skilled in the art can easily understand other advantages and efficacy of the present invention disclosed by this specification of the content. The present invention can also be implemented or applied by other different specific examples. The details of the invention may also be a variety of modifications and changes, based on different perspectives and application, and without departing from the spirit of the present invention.

Notice, the structure, proportion, size, etc. in drawings of the present invention are only to fit the disclosed contents of the present invention, for persons familiar with this art to understanding and reading, not intended to limit the qualification of the present invention may be implemented. Therefore, no real meaning of the technology with any modification of the structure, proportion, size, etc. In the case of it does not affect the efficacy and purpose shall fall within the scope of the technical content disclosed of the present invention.

The following description of the side grating based light coupling system in accordance with an embodiment of the present application.

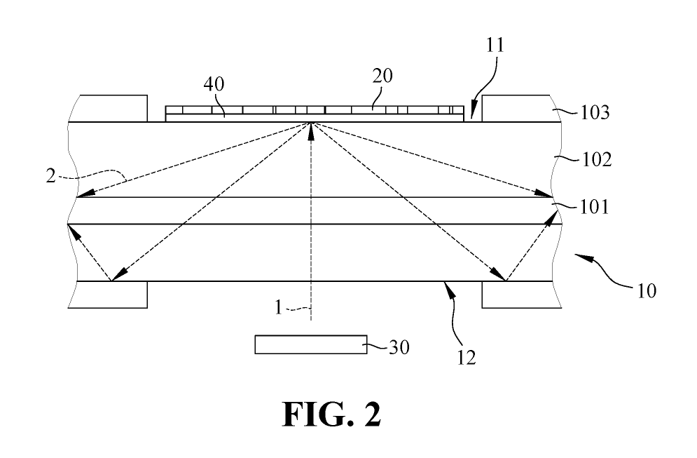

As shown in FIG. 2, a side grating based light coupling system of the present invention comprises an optical fiber 10, a side grating 20, and a laser array 30.

The optical fiber 10 includes a first side wall 11 and a second side wall 12 opposite to the first side wall. According to an embodiment of the present invention, the optical fiber 10 comprises a core 101, a fiber cladding 102 and a protective layer 103. The core 101 is located in the center of the optical fiber 10 and parallel to the axial of the optical fiber 10. The fiber cladding 102 is coated on the sidewall of the core 101. The outermost layer of the core 101 is the fiber protection layer 103 which is coated on the fiber cladding 102. The first side wall 11 and the second side wall 12 are respectively formed on two places of the fiber cladding 102 which is not covered the fiber protection layer 103.

In addition, the core 101 of the optical fiber 10 may include active ions such as ytterbium, erbium, or other similar media, so that a light source with a specific wavelength propagates in the core 101 provides gain.

The side grating 20 attached to the first side wall 11 of the optical fiber 10, and includes a plurality of grating elements arranged in non-uniform arrangement (not shown). In the embodiment of the present invention, the side grating 20 has a substrate (not shown), the plurality of grating elements (not shown) are disposed on the substrate, and toward the first side wall 11 of the optical fiber 10.

In the embodiment, the plurality of grating elements (not shown) comprise a plurality of first structures (not shown) and a plurality of second structures (not shown), and the plurality of first structures (not shown) and the plurality of second structures (not shown) are non-single periodically arranged. The plurality of first structures (not shown) are disposed in central positions of the side grating 20, and the plurality of second structures (not shown) are disposed in non-central of the side grating 20.

The laser array 30 is disposed on the second side wall 12 of the optical fiber 10, and the laser array 30 is used to emit a laser beam 1. The laser beam 1 sequentially goes through the second side wall 12 and the first side wall 11 of the optical fiber 10, and the laser beam 1 is converted into at least one laser beam through the plurality grating elements (not shown) of the side grating 20. The diffraction efficiencies of the converted laser beams 2 are different. The converted laser beams propagate inside the optical fiber 10 based on total internal reflection. In the embodiment of the present invention, the laser array 30 is a semiconductor laser array, and it could be a narrow bandwidth semiconductor laser diode which emits a specific wavelength absorbed by the gain medium. After the gain medium absorbs the light source, the gain medium can generate the power gain.

In the embodiment of the present invention, the side grating based light coupling system further includes a buffer layer 40, the buffer layer 40 is a refractive index matching material, and the side grating 20 is attached to the first side wall 11 of the optical fiber 10 through the buffer layer 40.

As the side grating based light coupling system of the present invention is started, the laser array 30 emits the laser beam 1 toward the second side wall 12 of the optical fiber 10, and the laser beam 1 sequentially goes through the second side wall 12 and the first side wall 11 of the optical fiber 10. Then, the laser beam 1 is converted into at least one diffracted light which is asymmetric by the plurality grating elements of the side grating 20, and furthermore, the at least one diffracted light is totally reflectively propagating in the optical fiber 10.

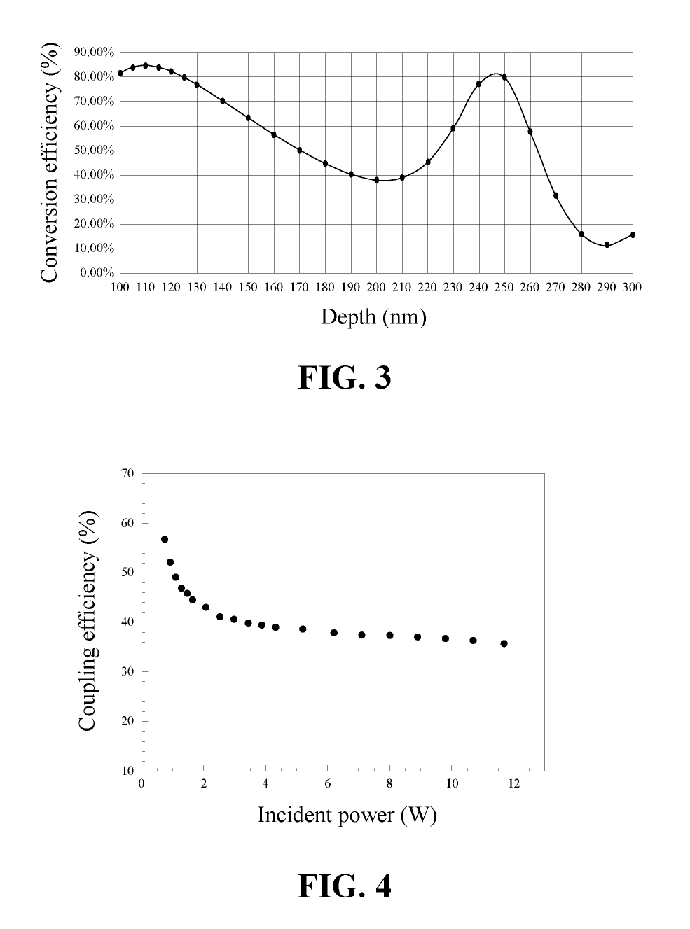

As shown in FIG. 3, FIG. 3 illustrates a diagram of the depth of the microstructure of a plurality of grating elements (not shown) and the overall energy conversion efficiency of the side grating based light coupling system of the present invention, it can be found that in the depth of the microstructure of a plurality of grating elements has a better overall energy conversion efficiency between certain nanoscale distances.

As shown in FIG. 4, FIG. 4 illustrates a diagram of the incident laser beam 1 power and the efficiency of coupling light of the side grating based light coupling system of the present invention, it can be found that when a low power laser beam is incident, the side grating based light coupling system is coupled with better optical system efficiency.

Thereby, since the plurality of grating elements (not shown) of the side grating 20 were arranged in non-uniform arrangement, it is not needed to load the optical collimating lens (not shown), and can reduce the secondary diffraction loss and scattering loss due to edge, to achieve the purpose with low costs to improve the energy conversion efficiency.

Although many of the present application with reference to illustrative embodiments described embodiments, it should be understood that those skilled in the art can think of many other variations and embodiments, these changes and embodiments of the present disclosure will fall within the spirit and scope of the principles within. In particular, in the present disclosure, the drawings and the scope of the scope of the appended patent provided binding to the subject components and/or sets various changes and modifications may be made. In addition to the components and/or set to make changes and modifications, alternative uses for the skilled artisan will be apparent.

1. A side grating based light coupling system comprising:
an optical fiber, having a first side wall and a second side wall opposite to the first side wall;
a side grating, located near the first side wall of the optical fiber, wherein the side grating includes a plurality of grating elements arranged in non-uniform arrangement, the grating elements having a depth in a range of 100 nm to 270 nm; and
a laser array, disposed adjacent to the second side wall of the optical fiber, to emit a laser beam toward the optical fiber without cooperating with an optical collimating lens between the laser array and the optical fiber;
wherein the laser beam sequentially goes through the second side wall and the first side wall of the optical fiber, the laser beam is converted into a plurality of converted laser beams through the plurality grating elements with a conversion efficiency in a range of greater than or equal to 30% and less than 100% and wherein the converted laser beams propagate inside the optical fiber based on total internal reflection.

2. The side grating based light coupling system as claimed in claim 1, wherein the plurality of grating elements comprise a plurality of first structures and a plurality of second structures, the plurality of first structures and the plurality of second structures are non-single periodically arranged.

3. The side grating based light coupling system as claimed in claim 2, wherein the plurality of first structures are disposed in central positions of the side grating, and the plurality of second structures are disposed in non-central positions of the side grating.

4. The side grating based light coupling system as claimed in claim 1, wherein the laser array is a semiconductor laser array.

5. The side grating based light coupling system as claimed in claim 1, wherein the side grating has a substrate, the plurality of grating elements are disposed on the substrate, and toward the first side wall of the optical fiber.

6. The side grating based light coupling system as claimed in claim 1, further including a buffer layer, wherein the side grating is attached to the first side wall of the optical fiber by the buffer layer.

7. The side grating based light coupling system as claimed in claim 6, wherein the buffer layer is a refractive index matching material.

8. The side grating based light coupling system as claimed in claim 1, wherein the optical fiber comprises a core, fiber claddings and a protective layer.
